(19) United States
(12) Patent Application Publication
(10) Pub. No.: US 2006/0118989 A1
(43) Pub. Date: Jun. 8, 2006

(54) Method of making composite material

(75) Inventors: Madeline P. Shinbach, St. Paul, MN (US); Michael C. Martin, Hudson, WI (US); Domasius Nwabunma, Woodbury, MN (US); Harry J. Marshall, Hudson, WI (US); Lee E. Olsen, Stillwater, MN (US); Bridget A. Bentz, Brooklyn Park, MN (US); Soemantri Widagdo, St. Paul, MN (US)

Correspondence Address: 3M INNOVATIVE PROPERTIES COMPANY, PO BOX 33427, ST. PAUL, MN, 55133-3427, US

(73) Assignee: 3M Innovative Properties Company

(21) Appl. No.: 11/007,530

(22) Filed: Dec. 7, 2004

(51) Int. Cl. B29C 47/38; B29C 47/60; B29C 47/76

(52) U.S. Cl. 264/102; 264/211; 264/211.21; 264/211.23

(57) ABSTRACT

A method of making a composite material wherein a molten polymeric material is added to frangible solid particulates within a screw extruder.

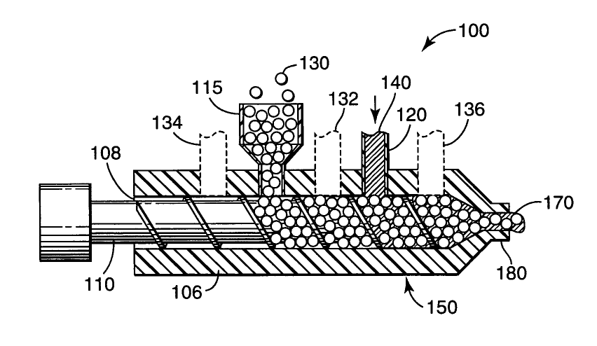

### BACKGROUND

Frangible solid particulates such as, for example, glass bubbles or fibers are commonly incorporated into polymeric materials to form various composite materials. In one common method, the frangible solid particulate and molten polymeric material are combined in a vessel with simple mixing. While such process may lead to high quality mixtures (e.g., having little entrapped gas and with a low level of breakage of the frangible solid particulates) this type of batch process is typically more time consuming and/or expensive than a continuous type of process.

Various continuous processes for combining frangible solid particulates and molten polymeric materials have been devised, but those processes typically lead to larger amounts of entrapped gas and/or broken frangible solid particulates than the above-mentioned type of batch process, particularly in the case of frangible solid particulates (e.g., glass bubbles or fibers). For example, in one common continuous process glass bubbles are added to a molten polymer stream located within the barrel of an extruder. That process typically results in significant amount of entrapped gas (e.g., air) and breakage of the glass microbubbles, which typically results in composite materials having higher or lower density than desired.

### SUMMARY

In one aspect, the present invention provides a method of making a composite material, the method comprising:

providing an extruder having a housing, a barrel defined by the housing, and at least one screw at least partially disposed within the barrel, a first inlet port that extends through the housing and opens to the barrel, a second inlet port that extends through the housing and opens to the barrel and is disposed downstream from the first inlet port, and an outlet port that opens to the barrel and is downstream from the second inlet port;

introducing a plurality of frangible solid particulates into the first inlet port such that the frangible solid particulates are engaged by the screw;

introducing a molten polymeric material into the extruder through the second inlet port such that the molten polymeric material engages the screw and combines with the frangible solid particulates to form a molten composite material comprising a dispersion of the frangible solid particulates in the molten polymeric material; and

obtaining the molten composite material from the outlet port.

In some embodiments, the molten polymeric material may comprise a thermosetting resin, thermoplastic resin, or a combination thereof.

According to the present invention, it is typically possible to combine frangible solid particulates with molten polymeric material in a continuous process while achieving a relatively low quantity of entrapped gas. Further, a relatively low quantity of broken frangible solid particulates may also be achieved in many cases.

Methods according to the present invention as useful, for example, for preparing composite materials.

As used herein,

the term “barrel” refers to a hollow cavity disposed within the body of an extruder, and in which one or more screws generally aligned with the barrel are disposed;

the term “upstream” means located at a position along the screw that is located further away from the outlet port; and

the term “downstream” means located at a position along the screw that is located closer to the outlet port.

### BRIEF DESCRIPTION OF THE DRAWING

The drawing is a cutaway view of an exemplary process according to the present invention.

### DETAILED DESCRIPTION

Frangible solid particulates that may be used in practice of the present invention include, for example, organic and/or inorganic frangible solid particulates. The frangible solid particulates may be homogenous or heterogeneous (e.g., composite particles or hollow beads) and may have any shape (e.g., spherical or elongated). The frangible solid particulates should typically be solid over the range of temperatures used in practice of the present invention, although they may soften or melt at higher temperatures.

Examples of suitable organic frangible solid particulates include synthetic thermoplastic or thermoset polymeric microspheres.

Examples of suitable inorganic frangible solid particulates include glass beads; glass bubbles (e.g., hollow glass microspheres or glass microbubbles); hollow or filled ceramic microspheres; glass flakes; staple fibers such as, for example, boron, carbon, graphite, glass, or ceramic staple fibers; and combinations thereof. Combinations of organic and inorganic particulates may also be used.

The average size of the frangible solid particulates may be in a range of from at least 10, 20, 30 or 50 micrometers up to and including 50, 150, 250, or even 500 micrometers in diameter, although larger and smaller particulates may also be used.

The frangible solid particulates may have a multimodal (e.g., bimodal or trimodal) distribution (e.g., to improve packing efficiency) as described, for example, in U.S. Pat. Appl. Publ. No. 2002/0106501 A 1 (Debe).

Examples of commercially available glass bubbles include those marketed by 3M Company under the trade designation “3M SCOTCHLITE GLASS BUBBLES” (e.g., grades K1, K15, S15, S22, K20, K25, S32, K37, S38, K46, S60/10000, A16/500, A20/1000, A20/1000, A20/1000, A20/1000, H50/10000 EPX, and H50/10000 (acid washed);) glass bubbles marketed by Potter Industries, Valley Forge, Pa., under the trade designation “SPHERICEL” (e.g., grades 110P8 and 60P18), “LUXSIL”, and “Q-CEL” (e.g., grades 30, 6014, 6019, 6028, 6036, 6042, 6048, 5019, 5023, and 5028); hollow glass microspheres marketed under the trade designation “DICAPERL” by Grefco Minerals, Bala Cynwyd, Pa. (e.g., grades HP-820, HP-720, HP-520, HP-220, HP-120, HP-900, HP-920, CS-10-400, CS-10-200, CS-10-125, CSM-10-300, and CSM-10-150); hollow glass particles marketed by Silbrico Corp., Hodgkins, Ill. under the trade designation “SIL-CELL” (e.g., grades SIL 35/34, SIL-32, SIL-42, and SIL-43).

Examples of commercially available hollow ceramic microspheres include ceramic hollow microspheres marketed by Potter Industries under the trade designation “EXTENDOSPHERES” (e.g., grades SG, CG, TG, SF-10, SF-12, SF-14, SLG, SL-90, SL-150, and XOL-200); ceramic hollow microspheres marketed by 3M Company under the trade designation “3M ZEEOSPHERE” (e.g., grades G-200, G-400, G-600, G-800, G-850, W-210, W-410, and W-610).

Examples of commercially available ceramic fibers include ceramic fibers marketed by 3M Company under the trade designation “NEXTEL” (e.g., “NEXTEL 312”, “NEXTEL 440”, “NEXTEL 550”, “NEXTEL 610”, and “NEXTEL 720”).

The density of the frangible solid particulates may be of any value. For example, the average density of the frangible solid particulates may be in a range of from at least 0.1 or 0.3 grams per milliliter up to and including 0.6, 1.1 or even 3.0 grams per milliliter or more.

Advantageously, methods according to the present invention may be used to combine molten polymeric materials (e.g., molten thermoplastic polymers) with frangible solid particulates. In such cases, by practicing the methods according to the present invention, it is generally possible to reduce breakage of the frangible solid particulates relative to those methods in which the frangible solid particulates are added to the molten polymeric material while it is traveling within the barrel of an extruder.

Useful molten polymeric materials include, for example, molten thermoplastic resins, molten thermosetting resins, molten glasses, and blends and mixtures thereof.

Examples of thermoplastic resins include polyolefins (e.g., polyethylene and polypropylene such as those marketed by Dow Chemical Co., Midland, Mich. under the trade designations “ENGAGE 8200”, “ATTANE”, “LINEAR LOW DENSITY POLYETHYLENE 6806” “FLEXOMER 1137” and “FLEXOMER 1138”), acrylonitrile-butadiene-styrenes (e.g., those marketed by General Electric Co., Pittsfield Mass. under the trade designation “CYCOLAC”), polyamides (e.g., those marketed by E.I. du Pont de Nemours & Co., Wilmington, Del., under the trade designations “NYLON” and “ZYTEL”), polycarbonates (e.g., those marketed by General Electric Co. under the trade designation “LEXAN”), polyvinyl chloride (plasticized or unplasticized); ethylene vinyl acetates (e.g., those marketed by E.I. du Pont de Nemours & Co. under the trade designation “ELVAX” and by ExxonMobil Corp., Houston, Tex., under the trade designation “ESCORENE”, polyesters (e.g., polyethylene terephthalate and polycaprolactone), polyimides, cellulose esters (e.g., cellulose acetate), polyurethanes, polyureas, acrylics, fluoropolymers, ionomers, polyether blocked polyamide thermoplastic elastomers, polyimides, acrylonitrile-butadiene-styrene polymers, acetals, acrylics, cellulosics, and other extrudable thermoplastics, and combinations thereof.

Useful thermosetting resins include, for example, epoxies, polyisocyanates, alkyd resins, phenolics, epoxy-acrylics, epoxy-functionalized polyolefins, and combinations thereof. If present, temperatures used in the extruder should typically be kept sufficiently low that significant polymerization of the thermosetting resin occurs within the extruder.

The molten polymeric material may optionally further comprise various adjuvants including, for example, plasticizers, toughening agents, coupling agents, thixotropic agents, pigments, fillers, reinforcing materials, and combinations thereof.

The molten polymeric material may be devolatilized and/or degassed prior to feeding it into the extruder via the second inlet port. This generally helps reduce the number of void spaces that are typically present in the composite material.

Screw extruder technology is well known in the art. Useful screw extruders include, for example, single-screw and twin-screw extruders, multi-stage screw extruders, and reciprocating screw extruders. Typically, the screws in these extruders are generally helical, and may be of even or variable pitch. In some extruders, the screw(s) are continuous, while in others they are discontinuous. A discussion of screw extruder technology may be found, for example, in “Encyclopedia of Polymer Science and Engineering”, Vol. 6, Wiley-Interscience: New York, c1986, pages 571-631 and in Plastics Materials & Processes by S. Schwartz et al., Van Nostrand Reinhold: New York, c 1982, pages 578-590. Further details concerning suitable screw extruders include, for example, those disclosed in U.S. Pat. No. 3,082,816 (Skidmore), the disclosure of which is incorporated herein by reference.

Multi-screw extruders typically comprise one or more screws, a die at the downstream end through which extrusion takes place, and an inlet port for introducing materials located at or near the upstream end. They may also have one or more additional inlet ports and/or vents distributed at various positions along the barrel. The vents are normally constructed so that a vacuum may be drawn through them, facilitating removal of volatiles. Also present in most instances are heating means, which facilitate bringing the material being extruded to a temperature adapted for removal of volatiles. The screws may optionally contain elements such as forward-flighted screw elements designed for simple transport, and reverse-flighted screw and cylindrical elements to provide intensive mixing and/or create a seal. One particularly useful type of extruder is a co-rotating, fully intermeshing twin-screw extruder, for example, as commercially available from APV Chemical Machinery, Saginaw, Mich.

Referring now to the drawing, method 100 illustrates one embodiment of the present invention. Frangible solid particulates 130 are added to first inlet port 115 of extruder 150 having housing 106 and screw 110 disposed within barrel 108. Frangible solid particulates 130 are conveyed by screw 110 to a point where they are combined with molten polymeric material 140, which is introduced through second inlet port 120 that is downstream from the first inlet port. Volatiles may be removed through optional vents 132, 134, and 136. Composite material 170 is removed from extruder 150 via outlet port 180.

The frangible solid particulates are fed into the extruder through a first inlet port. The first inlet port is typically mounted on the top or side of the extruder housing, but may be mounted in any orientation that can supply the frangible solid particulates to the screw. The first inlet port may be gravity fed or may be fed by a mechanism such as, for example, an augur (e.g., a stuffer or crammer).

Typically, the molten polymeric material should be added to the frangible solid particulates under relatively low shear conditions to minimize breakage and or air entrainment. This may be facilitated, for example, by increasing the temperature of the molten polymeric material (thereby reducing the viscosity) and/or by including processing aids in the molten polymeric material. The molten polymeric material may be added by a gravity fed mechanism, or by mechanical force (e.g., as from a separate extruder).

Methods according to the present invention are found to be effective at reducing caking of the frangible solid particulates that may cause unacceptable delays in processing and/or formation of inhomogeneous composite materials. Such problems are common when solid particulates are added to molten thermoplastic that is already within the body of the extruder. However, the present invention typically reduces this problem, thereby ensuring greater throughput and/or consistency than with the method as discussed above.

To facilitate processing, the frangible solid particulates may be added into the barrel of the extruder at less than full capacity of the screw (i.e., starve-fed mode). This typically reduces the force necessary to rotate the screw(s).

It is discovered according to the present invention that by feeding the frangible particulates into the first inlet port, the extruder may typically be operated at rotational screw speeds that are lower than those used in conventional processes such as, for example, those in which the frangible particulates are added to a polymer melt stream at a point downstream of the first inlet port. Use of slower screw speeds helps to control overheating of the molten composite material, which may occur due to the increased viscosity (and accompanying viscous heating caused, for example, by rotation of the screw(s)) that typically occurs upon mixing the molten polymeric material with the frangible solid particulates. Such overheating may result in undesirable degradation of the molten polymeric material. Thus, the present invention may facilitate preparation of composite materials at relatively higher volume loadings than are typically achievable by existing methods.

The frangible solid particulates may be heated (for example within the barrel of the extruder) prior to combining the frangible solid particulates with the molten polymeric material. This approach is particularly useful for reducing breakage of frangible solid particulates such as hollow glass or ceramic microspheres and glass or ceramic fibers.

The screw extruder typically has at least one vent suitable for removal of gases and other volatile components. The vent(s) may be situated at various locations along the length of the extruder barrel including, for example, upstream from the second inlet port, between the first and second inlet ports, and upstream from the first inlet port. Typically, the vents have a reduced pressure (e.g., a pressure of less than 10 torr (1.3 kilopascals)) to facilitate effective removal of volatile components, but higher pressures may also be used.

The molten composite material may be cooled and/or otherwise solidified after it is obtained from the outlet port of the extruder.

By adding the molten polymeric material to the frangible solid particulates in the barrel of the screw extruder, according to some embodiments of the present invention, it is typically possible to achieve low levels of entrained gases. For example, in such embodiments, the included volume of trapped gas in solidified composite material, exclusive of the frangible solid particulates, may be less than or equal to 4, 3, 2, or even 1 percent by volume, based on the total volume of the solidified composite material.

Advantageously, according to the present invention the frangible solid particulates may comprise up to and including 30, 40, 50, 60, 65, or even 75 percent by volume, or more, based on the total volume of the composite material and/or solid polymer composite material while having a low incidence of breakage (e.g., less than or equal to 1.2 percent by volume based on the total volume of the composite material).

In some embodiments, on a total volume basis, the frangible solid particulates may comprise from at least 30 or 40 percent up to and including 50 or 60 percent by weight, by weight based on the total weight of the composite material, although greater and lesser amount may also be used.

In the case that the solid particles are hollow microspheres, methods according to the present invention are useful for preparing low-density composite materials with a relatively high degree of uniformity and crush strength for use, among other things, as thermal insulation, electrical insulation and jacketing, and sound insulation.

Objects and advantages of this invention are further illustrated by the following non-limiting examples, but the particular materials and amounts thereof recited in these examples, as well as other conditions and, details, should not be construed to unduly limit this invention.

### EXAMPLES

Unless otherwise noted, all parts, percentages, ratios, etc. in the examples and the rest of the specification are by weight, and all reagents used in the examples were obtained, or are available, from general chemical suppliers such as, for example, Sigma-Aldrich Company, Milwaukee, Wis., or may be synthesized by conventional methods.

Test Methods

Determination of Volume Percent of Average Broken Glass Microbubbles and Volume Percent of Entrained Gas

A furnace oven was heated to 600° C. and a ceramic crucible was placed in the furnace for 5 minutes. The crucible was cooled in a desiccator and then weighed. A sample of the composite material to be tested was placed in the crucible and the sample and crucible were weighed, and placed in the furnace oven heated at 600° C. for 30 minutes. The crucible was removed from the furnace, cooled in a desiccator and then weighed, yielding the mass of the crucible and the residual glass. The following masses were calculated:
m_{c}=(mass of crucible and sample)−mass of crucible
m_{g}=(mass of crucible and residual glass)−mass of crucible
mₚ=(mass of crucible and sample)−(mass of crucible and residual glass)

The following equation was used to calculate the volume percent of broken glass microbubbles, xᵥ:

$${x}_{v} = \frac{{ρ}_{c} - {ρ}_{gu}}{{ρ}_{gb} - {ρ}_{gu}}$$

wherein ρ_{c} is measured density of composite material, ρ_{gu} density of unbroken glass microbubbles, and ρ_{gb} density of broken glass microbubbles.

The following equation is used to calculate the volume percentage of entrained gases, χ_{gas}:

$${x}_{gas} = \frac{\frac{{m}_{c}}{{ρ}_{c}} - \frac{{m}_{p}}{{ρ}_{p}} - \frac{{m}_{g}}{{ρ}_{g}}}{\frac{{m}_{c}}{{ρ}_{c}}}$$

wherein m_{c} and ρ_{c} are the mass and density of composite material respectively, mₚ and ρₚ are the mass and density of polymer respectively, and m_{g} and ρ_{g} are the mass and density of the residual glass (containing broken and unbroken bubbles), respectively.
Average Particle Density Determination

A fully automated gas displacement pycnometer obtained under the trade designation “ACCUPYC 1330 PYCNOMETER” from Micromeritics, Norcross, Ga., was used to determine the density of the composite material and glass residual according to ASTM D-2840-69, “Average True Particle Density of Hollow Microspheres”.

Preparation of Glass Microbubbles

The process that was followed for making glass microbubbles is essentially described in U.S. Pat. No. 4,391,646 (Howell; Example 1) and the composition of the glass used is described in U.S. Pat. No. 4,767,726 (Marshall; Example 8). Glass microbubbles used to make composite materials typically had a 90 percent size range of 10-60 micrometers and an average particle density of 0.4 g/mL.

### Comparative Example C-1

Comparative Example C-1 was a composite material extruded using a co-rotating, fully intermeshing twin-screw extruder (Model MP-2050TC, available from APV Chemical Machinery, Saginaw, Mich., that consisted of two 50.8 mm diameter screws with a Length/Diameter (L/D) ratio of 45. The extruder was set-up for 10 temperature zones, Zone 1-Zone 10 (Zone 1=300° F. (149° C.), Zone 2=319° F. (160° C.) 365° F. (185° C.), and Zones 4-10=374° F. (190° C.)). The extruder was interfaced with a 20 mL/revolution gear pump.

Pelletized maleated polypropylene, available under the trade designation “EPOLENE G3003” from Eastman Chemical, Kingsport, Tenn. (MFI=380 g/10 minutes) was supplied to the twin screw extruder, described above, at Zone 1 (Z1). The extruder screw speed was 225 rpm, and throughput was set at 22 lb/hr (10 kg/hr). Glass microbubbles were added via a gravimetric feeder into the open port at a feed rate of 18 lb/hr (8.2 kg/hr) approximately 58.4 cm downstream from Zone 1 (Z1). A vacuum port vent on the twin-screw extruder was located 171.0 cm downstream from Zone 1 (Z1). The glass microbubble loading was 45 percent by weight and 64 percent by volume (glass microbubble density was 0.42 g/mL and the density of “EPOLENE G3003” was 0.91 g/mL). The composite material was extruded through a die (8 round holes; each hole having a 0.093 inch (2.36 mm) diameter) and was cooled and pelletized using an underwater pelletizer (model 5; available from Gala Industries, Eagle Rock, Va.). Cooled composite material was put through a centrifugal drier and placed drums lined with in polyethylene plastic bags. Average breakage of the glass microbubbles in the cooled composite material was 1.3 percent and average trapped gas in the composite material was 8.9 percent by volume.

### Comparative Example C-2

Comparative Example C-2 was prepared according to the procedure described in Comparative Example C-1, with the exception that the vacuum port vent on the twin-screw extruder was located 62 cm downstream from Zone 1 (Z1) and the glass microbubbles were added approximately 171 cm downstream from Zone 1 (Z1). Average breakage of the glass microbubbles in the cooled composite material was 1.3 percent and average trapped gas in the composite material was 6.4 percent by volume.

### Example 1

Example 1 was prepared following the procedure described for Comparative Example C-I with the exception that the vacuum port vent on the twin screw extruder was located at Zone 1 (Z1), and the glass microbubbles were added using a gravimetric feeder located 38.0 cm downstream from Zone 1 (Z1) and molten polymer was added 116.0 cm downstream from Zone 1 (Z1). The extruder screw speed was 75 rpm. Average breakage of the glass microbubbles in the cooled composite material was 1.2 percent and average trapped gas in the composite material was 3.5 percent by volume.

Various modifications and alterations of this invention may be made by those skilled in the art without departing from the scope and spirit of this invention, and it should be understood that this invention is not to be unduly limited to the illustrative embodiments set forth herein.

What is claimed is:

1. A method of making a composite material, the method comprising:
providing an extruder having a housing, a barrel defined by the housing, and at least one screw at least partially disposed within the barrel, a first inlet port that extends through the housing and opens to the barrel, a second inlet port that extends through the housing and opens to the barrel and is disposed downstream from the first inlet port, and an outlet port that opens to the barrel and is downstream from the second inlet port;
introducing a plurality of frangible solid particulates into the first inlet port such that the frangible solid paiticulates are engaged by the screw;
introducing a molten polymeric material into the extruder through the second inlet port such that the molten polymeric material engages the screw and combines with the frangible solid particulates to form a molten composite material comprising a dispersion of the frangible solid particulates in the molten polymeric material; and
obtaining the molten composite material from the outlet port.

2. A method according to claim 1, further comprising solidifying the molten composite material.

3. A method according to claim 2, wherein the included volume of trapped gas in the solidified composite material, exclusive of the frangible solid particulates, is less than 4 percent by volume, based on the total volume of the solidified composite material.

4. A method according to claim 2, wherein the solidified composite material contains less than or equal to 1.2 percent by volume of broken frangible solid particulates, based on the total volume of the solidified composite material.

5. A method according to claim 1, wherein the extruder further comprises a vent that extends through the housing and opens to the barrel.

6. A method according to claim 5, wherein the vent is located upstream from the first inlet port.

7. A method according to claim 5, wherein the vent is located between the first and second inlet ports.

8. A method according to claim 5, wherein the vent is located downstream from the second inlet port.

9. A method according to claim 5, wherein the extruder comprises at least two screws that are at least partially disposed in the barrel.

10. A method according to claim 5, wherein the vent has a pressure of less than 1.3 kilopascals.

11. A method according to claim 1, further comprising at least partially devolatilizing the molten polymeric material prior to introducing it into the second inlet port.

12. A method according to claim 1, further comprising heating the frangible solid particulates while the frangible solid particulates are disposed within the barrel and prior to combining them with the molten polymeric material.

13. A method according to claim 1, wherein the average size of the frangible solid particulates is in a range of from at least 10 up to and including 150 microns in diameter.

14. A method according to claim 1, wherein the frangible solid particulates comprise at least one of glass microbubbles, chopped glass fibers, or hollow ceramic microspheres.

15. A method according to claim 1, wherein the frangible solid particulates comprise glass microbubbles.

16. A method according to claim 1, wherein the frangible solid particulates have a multimodal size distribution.

17. A method according to claim 1, wherein the average density of the frangible solid particulates is in a range of from at least 0.1 grams per milliliter up to and including 3.0 grams per milliliter.

18. A method according to claim 1, wherein, on a total volume basis, the frangible solid particulates comprise from at least 40 percent up to and including 60 percent by volume, based on the total volume of the composite material.

19. A method according to claim 1, wherein the molten polymeric material comprises molten thermoplastic resin.

20. A method according to claim 19, wherein the molten thermoplastic resin is selected from the group consisting of polyolefins, ionomers, polyether blocked polyamide thermoplastic elastomers, polyimides, acrylonitrile-butadiene-styrene polymers, acetals, acrylics, cellulosics, chlorinated polymers, fluoropolymers, polyamides, polyesters, polycarbonates, and combinations thereof.
